(19) United States
(12) Patent Application Publication
(10) Pub. No.: US 2019/0315098 A1
(43) Pub. Date: Oct. 17, 2019

(54) POLY-SUPPORTED COPPER FOIL

(71) Applicant: Advanced Copper Foil Inc., Mississauga (CA)

(72) Inventor: Kieran HEALY, Mississauga (CA)

(73) Assignee: Advanced Copper Foil Inc., Mississauga (CA)

(21) Appl. No.: 16/451,806

(22) Filed: Jun. 25, 2019

Related U.S. Application Data
(62) Division of application No. 15/234,129, filed on Aug. 11, 2016.
(60) Provisional application No. 62/328,104, filed on Apr. 27, 2016.

(51) Int. Cl. B32B 15/09; B32B 15/20; H01B 3/42; B32B 27/36; H01B 1/02

(52) U.S. Cl. CPC B32B 15/09; B32B 15/20; H01B 3/42; B32B 2255/10; H01B 1/02; B32B 2457/00; B32B 2255/26; B32B 27/36

(57) ABSTRACT

A method for manufacturing a printed circuit board (PCB) comprises firstly constructing a first book which includes first and second supported copper foils located at the bottom and top respectively. Each supported copper foil includes a respective poly-based film, a thin copper foil, and an adhesive provided between the film and the thin foil; the adhesive being permanently attached to the film and removably attached to the thin foil. The first book further comprises a first prepreg adjacent the thin foil of the first foil, copper clad laminates adjacent the first prepreg, and a second prepreg on a side of the copper clad laminates that opposes a side adjacent the first prepreg. Next, applying a lamination cycle to the first book using a laminating press to cure the first and second prepregs. Finally, removing the films from the thin foils associated with each of the first and second supported foil.

### TECHNICAL FIELD

The present application relates to thin copper foils and, more particularly, to supported copper products and methods for manufacturing and using such supported copper products.

### BACKGROUND

Copper foils are used in various electronics applications including, for example, in printed circuit boards (PCB), batteries (e.g., where they may be used for battery wrapping) and shielding (e.g., for radio frequency identification (RFID) shielding, lighting strike shielding, etc.). In many applications, copper foils have become thinner in recent years. For example, in recent years, thin and ultrathin copper foils have gained more widespread adoption. The term “thin” copper foil generally refers to copper foil having a thickness of 12 microns or less. The term “ultrathin” copper foil generally refers to copper having a thickness of 9 microns or less.

As copper foils have become thinner, new problems have emerged due to the fragile nature of the “thin” and “ultrathin” copper foils. More particularly, thin and ultrathin copper foils are flexible and handling of such foils can cause bending, creasing, or other imperfections in the copper. Such imperfections in the copper can result in imperfections in the end product that includes the copper product. For example, a PCB manufactured using a copper foil having an imperfection, such as a bend, may be defective.

In order to address this problem, manufacturers of “thin” and “ultrathin” copper foils often removably attach such copper foils to a copper carrier. The copper carrier is often relatively thick in comparison to the copper foil itself. For example, some manufacturers support a nine (9) micron copper foil on a seventy (70) micron copper carrier. The copper carrier is attached to the copper foil using a release layer, such as an inorganic coating. The copper carrier provides rigidity to the copper foil which prevents handling defects such as bending and is removed from the copper foil during manufacture of the end product; for example, during manufacture of a PCB. The copper carrier is not included in the end product that is manufactured using the copper foil but rather is discarded.

Notably, since the copper carrier is relatively thick in comparison to the copper foil, the copper carrier substantially increases the cost of such foils. Furthermore, the copper carrier is typically added to the copper foil using a plating process and, since the copper carrier is thick, the drum that is used in the plating process must operate slowly in order to achieve the desired thickness. This causes the manufacturing process of copper-supported products to be slow.

### BRIEF DESCRIPTION OF THE DRAWINGS

Reference will now be made, by way of example, to the accompanying drawings which show embodiments of the present application, and in which:

FIG. 1 is a perspective view of a supported copper foil;

FIG. 2 is a side view of the supported copper foil of FIG. 1;

FIG. 3 is a side view of an example lamination press arrangement;

FIG. 4 is a side view of an example book for use in the lamination press arrangement of FIG. 3;

FIG. 5 is a flowchart of an example method of manufacturing a printed circuit board;

FIG. 6 is a block diagram of an example machine for manufacturing a supported copper product;

FIG. 7 is a block diagram of a further example machine for manufacturing a supported copper product; and

FIG. 8 is a flowchart of an example method of manufacturing a supported copper product.

Like reference numerals are used in the drawings to denote like elements and features.

### DETAILED DESCRIPTION OF EXAMPLE EMBODIMENTS

As will be described in greater detail below, in some embodiments, a supported copper foil is described. The supported copper foil includes a polyethylene terephthalate (PET) film, a thin copper foil, and an adhesive provided between the PET film and the thin copper foil, the adhesive removably coupling the PET film to the copper foil.

In another aspect, a method of manufacturing a supported copper product is provided. The method includes: providing a thin copper foil and a PET film, the PET film having an adhesive applied to a surface of the PET film; and attaching the thin copper foil to the PET film using the adhesive applied at the surface of the PET film.

In a further aspect, a machine for manufacturing a supported copper product is provided. The machine includes a first material handling unit for receiving a thin copper foil and a second material handling unit for receiving a PET film. The PET film has an adhesive applied to a surface of the PET film. The machine also includes at least one roller coupled with a drive. The drive rotates the roller to pull the thin copper foil into contact with the PET film to attach the thin copper foil to the PET film using the adhesive applied at the surface of the PET film.

In yet another aspect, a method for manufacturing a printed circuit board (PCB) is described. The method includes constructing a first book. The first book includes a first supported copper foil. The first supported copper foil comprises a polyethylene terephthalate (PET) film, a thin copper foil, and an adhesive provided between the PET film and the thin copper foil. The adhesive is permanently attached to the PET film and removably attached to the copper foil. The first book also comprises a first prepreg adjacent the thin copper foil of the first supported copper foil and one or more copper clad laminates adjacent the first prepreg. The first book further includes a second prepreg on a side of the one or more copper clad laminates that opposes a side adjacent the first prepreg. The first book also includes a second supported copper foil. The second supported copper foil comprising PET film, thin foil copper and an adhesive provided between the PET film and the thin copper foil. The adhesive is permanently attached to the PET film and removably attached to the copper foil. The second prepreg is adjacent the thin copper foil. The method further includes: applying a lamination cycle to the first book using a laminating press to cure the first prepreg and second prepreg, and, after the lamination cycle, removing the PET foil from the thin copper foil associated with the first supported copper foil and the PET foil from the thin copper foil associated with the second supported copper foil.

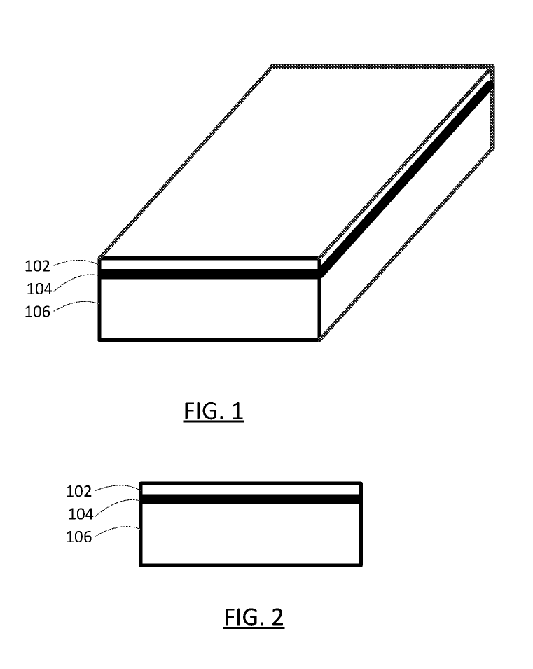

Reference will first be made to FIGS. 1 and 2 which illustrate an example supported copper foil 100. FIG. 1 illustrates a perspective view of the supported copper foil 100 while FIG. 2 illustrates a side view of the supported copper foil 100. The supported copper foil 100 may also be referred to as a poly-supported copper foil, a supported copper foil, or a supported copper product.

The supported copper foil includes a thin copper foil 102. “Thin” is used herein to refer to foils having a thickness of twelve (12) microns or less. The thin copper foil 102 may be an ultrathin copper foil. An “ultrathin” copper foil is a copper foil having a thickness of nine (9) microns or less. By way of example, in some embodiments, the copper foil has a thickness of approximately 9 microns. In some embodiments, the copper foil has a thickness of approximately 7 microns and in some embodiments, the copper foil has a thickness of approximately 5 microns.

As noted in the background section above, “thin” and “ultrathin” copper foils are fragile. In order to provide rigidity to such foils, a poly-based (i.e., a polyester-based) film 106 is removably attached to such copper foils. More specifically, an adhesive 104 is provided between the poly-based film 106 and the thin copper foil 102. The adhesive is permanently attached to the poly-based film and is removably attached to the thin copper foil 102. Thus, when the poly-based film 106 is detached from the thin copper foil 102, the adhesive remains on the poly-based film 106 and not the thin copper foil 102.

The poly-based film 106 aids in stiffening the thin copper foil and otherwise protects the thin copper foil 102. Accordingly, the poly-based film 106 may be referred to as a protective film. In addition to providing stiffening properties, the poly-based film 106 protects the thin copper foil 102 from dirt and debris.

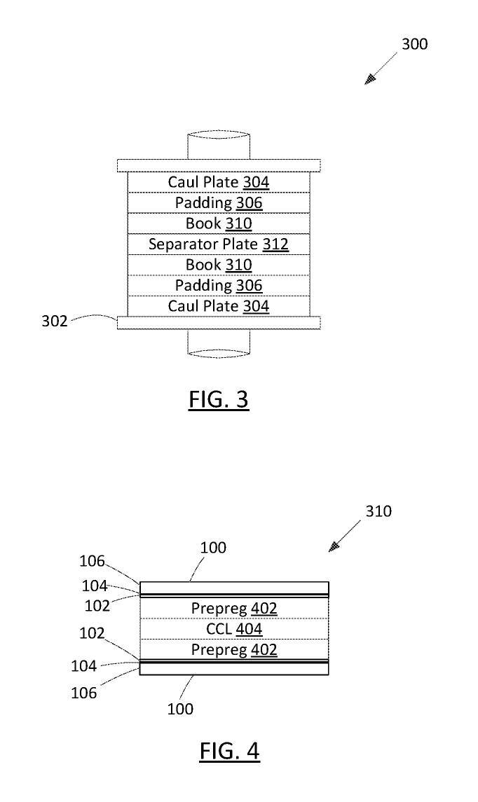

The thin copper foil 102 is manufactured for use in one or more applications which require the thin copper foil 102 to be subjected to high temperatures. For example, the thin copper foil 102 may be used in manufacturing printed circuit boards (PCBs) and, as will be described below in greater detail with reference to FIGS. 3 to 5, during the PCB manufacturing process the thin copper foil 102 may be subjected to temperatures in excess of 180 degrees Celsius or greater in order to cure prepreg and laminate a PCB. The specific temperatures that are required will depend on the nature of the prepreg used, but in some instances the temperatures may even exceed 200 degrees Celsius.

Notably, many poly-based films cannot be heated to such temperatures and would deteriorate under such conditions. Due to the sensitive nature of PCB manufacturing any deterioration that could leave residue on the PCB after manufacture could result in adverse effects, such as a non-functioning PCB.

The poly-based film 106 may be a polyethylene terephthalate (PET) film. Notably, while many poly-based films operate poorly in high-temperature environments, the PET film operates well in such environments. The PET film does not deteriorate under a heating temperature of one 180 degrees Celsius and does not deteriorate at heating temperatures of 200 degrees Celsius.

In some embodiments, the poly-based film 106 may be an Ethylene tetrafluoroethylene (ETFE) film. ETFE film also has a high temperature resistance and has been found to perform well in the temperature range of intended applications.

The poly-based film 106 is sufficiently thick to provide rigidity to the thin copper foil 102. In at least some embodiments, the poly-based film 106 has a thickness of 45 microns or greater. For example, in some embodiments, the poly-based film 106 has a thickness of between 45 and 100 microns.

The adhesive 104 used to removably couple the poly-based film 106 to the thin copper foil 102 is a low-tack adhesive that allows the thin copper foil 102 to be easily removed from the poly-based film 106 and the adhesive 104 (i.e., it can be removed by a human without mechanical assistance). For example, the adhesive may have a tack/adhesion strength less than or equal to 6 grams per 25 millimeter width. In some embodiments, the tack/adhesion strength is between 3 to 6 grams per 25 millimeter width.

The tack strengths referred to above refer to the tack strength that the adhesive has with the thin copper foil 102. The adhesive 104 adheres to the poly-based film 106 with a much greater force. For example, the adhesive may be permanently applied to the poly-based film 106. Thus, when the poly-based film 106 is separated from the thin copper foil 102, the adhesive 104 remains on the poly-based film 106 and not the thin copper foil 102.

In at least some embodiments, the adhesive 104 is a non-silicone based adhesive. Since silicone is a semi-conductor, the use of a silicone adhesive can cause defects in PCBs if any silicone residue is left on the thin copper foil 102 when the poly-based film 106 is detached from the thin copper foil 102.

The adhesive 104 may be an acrylic adhesive. Acrylic adhesives have good temperature performance. That is, the acrylic adhesive 104 does not degrade under the high temperatures that some applications of the product require. For example, the acrylic adhesive, in at least some embodiments, does not degrade at a temperature of 180 degrees Celsius. In at least some embodiments, the acrylic adhesive does not degrade at a temperature of 200 degrees Celsius. “Degrade”, as used herein with respect to the adhesive, means to break down in quality or consistency so as to leave behind adhesive residue on the thin copper foil when the thin copper foil and the poly-based film are detached from one another. That is, the adhesive is considered not to have degraded if continues to remove well from the thin copper foil.

The adhesive 104 is uniform across a surface of the poly-based film 106 and across a surface of the thin copper foil 102. That is, the adhesive 104 resides at all locations between the poly-based film 106 and the thin copper foil 102 and is applied at approximately the same coat weight irrespective of its location on the surfaces. For example, in at least some embodiments, the adhesive may be approximately 25 to 50 microns in thickness. The thickness of the adhesive may be the same across the entire surface of the poly-based film 106. Applying the adhesive across the entire surfaces of the thin copper foil 102 and the poly-based film 106 has been found to enhance rigidity of the thin copper foil 102.

Reference will now be made to FIG. 3, which illustrates an example lamination press arrangement 300 for one application of the high-temperature poly-based supported copper foil 100 of FIGS. 1 and 2.

The lamination press arrangement 300 of FIG. 3 includes a lamination press 302 used to manufacture a PCB. More particularly, in the example the lamination press 302 is used to manufacture a multi-layer PCB. The lamination press 302 is a specialized hydraulic press with heated platens 303. The heated platens 303 are used to cure prepreg. A prepreg (or pre-implregnated layer) is fiberglass that is impregnated with a resin (i.e., a thermosetting epoxy). The resin is dried but not hardened such that it flows when heated, by the lamination press 302, to a curing temperature.

The lamination press is configured to apply heat and pressure to layers which form the PCB to bond them together.

The lamination press 302 includes caul plates 304. The caul plates 304 include both an upper and a lower caul plate. The caul plates 304 (which may also be referred to as carrier plates or tooling plates) rest in the lamination press 302. More particularly, the caul plates 304 are adjacent the heated platens 303.

In at least some embodiments, padding 306 may be inserted between the caul plates 304 and the layers that will form the PCB. That is, there may be upper and lower padding 306, bounding the layers that will form the PCB. This padding 306 is used to control the rate of heat transfer between the heated platens 303 and the layers that will form the PCB. Further, the padding 306 can be used to compensate for imperfections such as non-parallel, bowed or warped platens, imperfections in the caul plates, etc. In some embodiments, the padding 306 may include several plies of thick Kraft paper. In some embodiments, the padding 306 may include press pad.

One or more books 310 are provided between the caul plates 304 and between the padding 306. In the example of FIG. 3, two books 310 are illustrated. However, a greater or lesser number of books may be inserted within the lamination press at any given time. For example, in some embodiments, only a single book is included. In other embodiments, a greater number of books are included. By way of example, in one embodiment, six books may be included in the lamination press at a given time.

The books 310 may be separated from one another by a separator plate 312. The separator plate 312 is a hard metal plate, such as stainless steel (in which case the separator plate may be referred to as a stainless steel separator plate).

Reference will now be made to FIG. 4 which illustrates an example book 310. The example book 310 includes two supported copper foils 100. The supported copper foils 100 are of the type described above with reference to FIGS. 1 and 2. A first one of the supported copper foils 100 is located at the bottom of the book 310 and a second one of the supported copper foils 100 is located at the top of the book 310. The poly-based film 106 of the supported copper foils 100 are outward facing. That is, the poly-based films 106 is the outside layer of the book 310. Notably, in this orientation, the poly-based films helps to provide some padding, much like the padding 306 discussed above. The padding provided by the poly-based films can help reduce the transmission of imperfections from the separator plates 312 or the caul plates 304 to the thin copper foil 102.

The thin copper foil 102 of the supported copper foils 100 are adjacent to and in contact with prepreg 402. For example, a first prepreg 402 is adjacent the thin copper foil 102 associated with the bottom one of the supported copper foils 100 and a second prepreg 402 is adjacent the thin copper foil 102 associated with the top one of the supported copper foils 100.

Between the first and second prepreg is one or more copper clad laminates (CCL) 404. That is, a first prepreg may be adjacent the thin copper foil of a first supported copper foil 100 and also adjacent the CCL 404 and a second prepreg may be located at a side of the CCL that opposes the side adjacent the first prepreg.

The copper clad laminate (CCL) may be a two-sided CCL 404. In the example, only a single CCL 404 is included to form a four-layer PCB. However, in practice there may be a greater number of CCLs included. Each CCL layer is separated from adjacent CCL layers with prepreg.

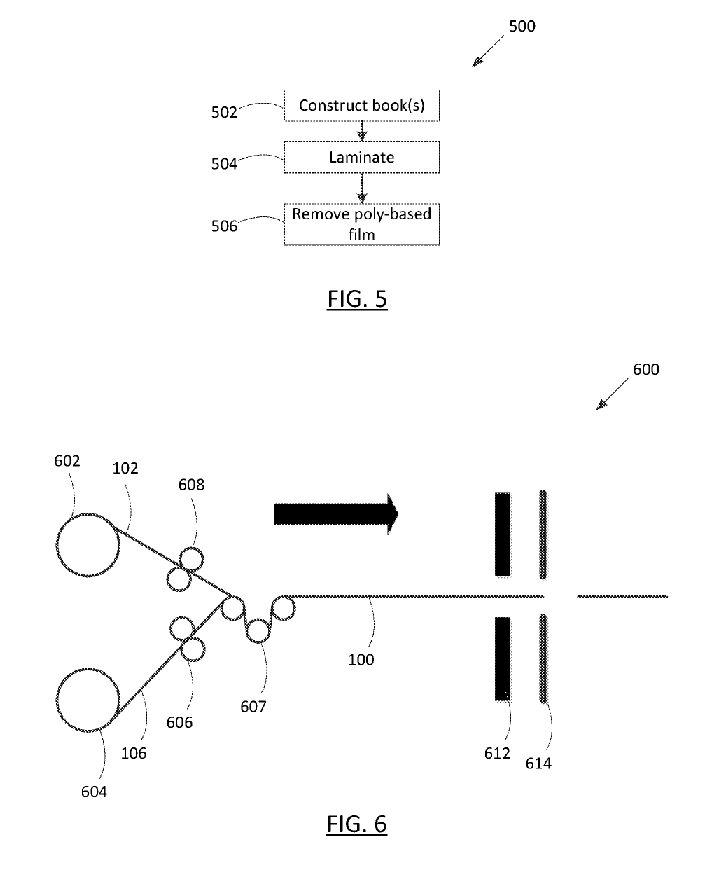

Referring now to FIG. 5, a method 500 of manufacturing a PCB will be described. The method 500 makes use of a supported copper foil 100 of the type described above with reference to FIGS. 1 to 2 and a lamination press 302 of the type described above with reference to FIG. 2.

The method includes, at operation 502, constructing one or more books 310 of the type described above with reference to FIG. 4. The books are generally constructed in a bottom-up fashion, beginning at the lowest layer in the stack-up and proceeding to the top layer. By way of example, a first book 310 may constructed by stacking a bottom supported copper foil 100 with the poly-based film 106 downwardly facing and the thin copper foil 102 upwardly facing and then adding a layer of prepreg 402 on top of the thin copper foil 102. A CCL 404 may then be added to the prepreg 402 and additional CCLs may be added, if desired, along with respective prepreg layers. Then, prepreg 402 is stacked on top of the uppermost CCL 404 and another supported copper foil 100 is added to that prepreg 402. This upper supported copper foil 100 is oriented so that the thin copper foil 102 faces downward and is in contact with the prepreg 402 and so that the poly-based film 106 faces upward. If multiple books are to be included in one lamination cycle, a separator plate 312 may be applied on a first side of the constructed book. More particularly, the separator plate 312 may be applied on top of the upper poly-based film 106 so that a further book may be stacked on top. This process may be repeated until the desired number of books are constructed.

At operation 504, a lamination cycle is applied to the book(s) using a lamination press 302 of the type described above with reference to FIG. 3 to cure the prepreg 402. The lamination is performed using specific predetermined operating characteristics, include specific times, temperatures and pressures. These characteristics depend, at least in part, on the prepreg that is used. The lamination cycle may heat the book(s) to at least 180 degrees Celsius, in some embodiments. In some embodiments, the lamination cycle may heat the book(s) to at least 200 degrees Celsius. The lamination cycle may, in some embodiments, take between 60 and 100 minutes. However, other lamination cycles may be used in other embodiments.

After the lamination cycle, de-booking occurs. In some embodiments, the book(s) may be subjected to a cooling cycle prior to de-booking. For example, cold water may be run over the book(s) to quickly cool them and an operator can then de-book.

At operation 506, the poly-based films 106 are removed from the book(s). That is, the poly-based films 106 are removed from respective thin copper foils. Notably, when this occurs, there is no banding of the adhesive; the acrylic adhesive removes cleanly and does not remain on the thin copper foil 102 after removal of the poly-based film 106. After the poly-based film is removed to expose the thin copper foil 102, the thin copper foil 102 may be etched.

While FIGS. 3 to 5 refer to an application of the supported copper foil 100 in which the supported copper product is used for the terminal layers of a multi-layer PCB, it will be understood that the supported copper foil 100 can have other uses and applications. For example, the supported copper foil 100 may be used for battery wrapping, and shielding (e.g., for radio frequency identification (RFID) shielding, lighting strike shielding, etc.) applications.

Furthermore, the supported copper foil 100 may, in some embodiments, be used to make a CCL itself. CCLs are generally manufactured by laminating prepreg between two layers of the supported copper foils 100. The manufacture of CCLs differs from the manufacture of PCBs described above in that the CCLs are cores which do not have other CCL layers provided therein. Rather, they are manufactured by providing a single prepreg layer between adjacent supported copper foils 100 (which the poly-based film externally facing) and laminating in a lamination press, which generally provides the same function as the lamination press of FIG. 3, but which may be much larger than the lamination press of the type described with reference to FIG. 3.

Techniques for manufacturing the supported copper foil 100 described above will now be discussed. Reference will first be made to FIG. 6, which illustrates, in block form, a sample machine 600 for manufacturing a supported copper product, such as the supported copper foil 100. The machine 600 may be located in a clean room environment, in some embodiments.

The machine includes a first material handling unit 602. The first material handling unit 602 receives the thin copper foil 102 of the type described herein with reference to FIGS. 1 and 2. The thin copper foil 102 may be received in roll form. In at least some embodiments, the material handling unit allows the roll to rotate.

The machine 600 also includes a second material handling unit. 604. The second material handling unit 604 is for receiving a poly-based film 106 of the type described above with reference to FIGS. 1 and 2. In at least some embodiments, the poly-based film 106 has an adhesive applied to a surface of the poly-based film 106. That is, one side of the poly-based film may have an adhesive 104 of the type described herein applied thereon. In at least some embodiments, a liner, such as a mylar liner, may act as a backing to the adhesive and the second material handling unit 604 may be configured to remove the liner. The poly-based film may be received in roll form. In at least some embodiments, the material handling unit allows the roll to rotate.

At least one roller 607 (or other material gripper) is provided in the machine, and, at least one of the rollers (or another material gripper) is coupled with a drive. The drive rotates the roller 607 (or otherwise drives the material gripper) causing the roller 607 to pull the thin copper foil into contact with the poly-based film to attach the thin copper foil to the poly-based film using the adhesive applied to the surface of the poly-based film.

The at least one roller 607 may be configured to remove any air bubbles between the poly-based film 106 and the thin copper foil 102 and may, in at least some embodiments, be configured to apply a force to the poly-based film 106 to hold the poly-based film taut during the attaching.

The machine 600 may also include a cleaner 606 for cleaning the poly-based film prior to the attaching. The cleaner 606 may include one or more adhesive take-up rollers which have a tack for removing debris. In some embodiments, the adhesive take-up rollers may include silicone rollers.

The machine 600 may also include a cleaner 608 for cleaning the thin copper foil 102 prior to the attaching. Such cleaners 608 may include one or more adhesive take-up rollers which have a tack for removing debris. In some embodiments, the adhesive take-up rollers may include silicone rollers.

The machine 600 may also include a punching station 612 which adds tooling holes for receipt in the lamination press 302. The punching station is located so that holes are applied after the thin copper foil has been attached to the poly-based film.

The machine 600 may also include a shearing station 614. The shearing station 614 cuts the supported copper foil into panels that fit within the lamination press 302. For example, in one embodiment, the supported copper foil is cut into 18″×24″ panels.

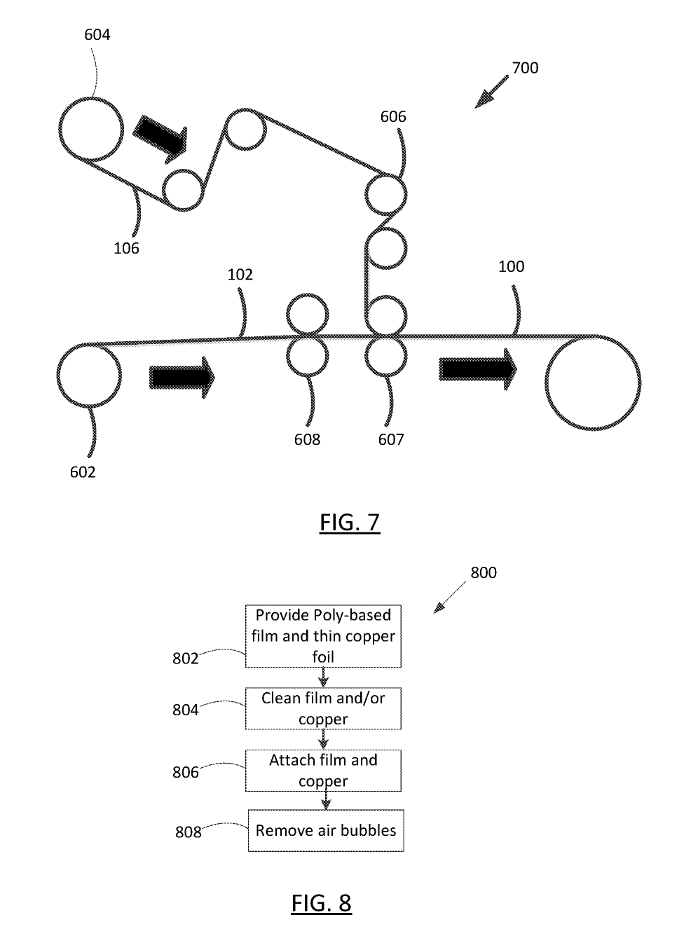

Reference will now be made to FIG. 7, which illustrates a second possible machine 600 for manufacturing a supported copper foil 100. The machine includes many features discussed above with reference to FIG. 6 and the discussion of such features will not be repeated at length. For example, a first material handling unit 602, second material handling unit 604, cleaners 606, 608 and rollers 607 are included. In the example of FIG. 7, at least some of the rollers are held in close proximity to one another to apply opposing forces to various sides of the supported copper foil 100 to remove any air bubbles.

The machine 700 of FIG. 7 differs from the machine 600 of FIG. 6, at least in part, by the fact that the machine 700 of FIG. 7 does not include a punching station or shearing station. If desired, such panelizing and tooling operations could be done offline. That is, the machine 700 may manufacture a roll of supported copper foil 100 and, if desired for a particular application, the roll could be post-processed to include tooling features and to cut the roll into smaller portions. It may be noted that some applications of the supported copper foil 100 may prefer or require delivery of the supported copper foil 100 in roll form. For example, while PCB manufacturing may rely on panels that are sized to fit a lamination press, battery manufacturers may prefer receiving the supported copper foil in roll format.

Reference will now to made to FIG. 8, which illustrates a flowchart of a method 800 for manufacturing a supported copper product, such as the supported copper foil 100 of FIGS. 1 to 2. The method 800 may be performed in a clean room environment.

At operation 802, the method 800 includes providing a thin copper foil 102 of the type described with reference to FIGS. 1 and 2 and a poly-based film 106 of the type described with reference to FIGS. 1 and 2. The poly-based film has an adhesive of the type described with reference to FIGS. 1 and 2 applied to a surface of the poly-based film.

In at least some embodiments, at operation 804, the poly-based film 106 and/or the thin copper foil 102 are cleaned. Such cleaning may be performed by passing the material over one or more adhesive take-up rollers that have a tack for removing debris. These take-up rollers may be, for example, silicone rollers.

At operation 806, the thin copper foil 102 is attached to the poly-based film using the adhesive applied to the surface of the poly-based film. For example, the thin copper foil 102 and the poly-based film 106 may be pressed into contact. The poly-based film may be held taut during the attaching.

At operation 808, the thin copper foil and the poly-based film may be processed to remove any air bubbles between these layers. For example, in some embodiments, the thin copper foil and the poly-based film are squeezed together by roller to roll out any air bubbles.

The various embodiments presented above are merely examples. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. A method for manufacturing a printed circuit board (PCB), the method comprising:
constructing a first book comprising:
a first supported copper foil, the first supported copper foil comprising a poly-based film, a thin copper foil, and an adhesive provided between the poly-based film and the thin copper foil, the adhesive being permanently attached to the poly-based film and removably attached to the copper foil;
a first prepreg adjacent the thin copper foil of the first supported copper foil;
one or more copper clad laminates adjacent the first prepreg;
a second prepreg on a side of the one or more copper clad laminates that opposes a side adjacent the first prepreg; and
a second supported copper foil, the second supported copper foil comprising a poly-based film, thin foil copper and an adhesive provided between the poly-based film and the thin copper foil, the adhesive being permanently attached to the poly-based film and removably attached to the copper foil, wherein the second prepreg is adjacent the thin copper foil,
applying a lamination cycle to the first book using a laminating press to cure the first prepreg and second prepreg; and
after the lamination cycle, removing the poly-based film from the thin copper foil associated with the first supported copper foil and the poly-based film from the thin copper foil associated with the second supported copper foil.

2. The method of claim 1, further comprising:
applying a separator plate on a first side of the first book;
constructing, a second book adjacent the separator plate, the second book comprising:
a first supported copper foil, the first supported copper foil comprising a poly-based film, a thin copper foil, and an adhesive provided between the poly-based film and the thin copper foil, the adhesive being permanently attached to the poly-based film and removably attached to the copper foil;
a first prepreg adjacent the thin copper foil of the first supported copper foil;
one or more copper clad laminates adjacent the first prepreg;
a second prepreg on a side of the one or more copper clad laminates that opposes a side adjacent the first prepreg; and
a second supported copper foil, the second supported copper foil comprising poly-based film, thin foil copper and an adhesive provided between the poly-based film and the thin copper foil, the adhesive being permanently attached to the poly-based film and removably attached to the copper foil, wherein the second prepreg is adjacent the thin copper foil.

3. The method of claim 2, wherein the separator plate is a stainless steel separator plate.

4. The method of claim 1, wherein the lamination cycle heats the first book to at least 180 degrees Celsius.

5. The method of claim 1, wherein the lamination cycle heats the first book to at least 200 degrees Celsius.

6. The method of claim 1, wherein the thin foil copper has a thickness of twelve microns or less.

7. The method of claim 1, wherein the thin foil copper is an ultrathin copper foil having a thickness of nine microns or less.

8. The method of claim 1, wherein the thin foil copper is an ultrathin copper foil having a thickness of seven microns or less.

9. The method of claim 1, wherein the thin foil copper is an ultrathin copper foil having a thickness of five microns or less.

10. The method of claim 1, wherein the adhesive is a low-tack adhesive that allows the thin copper foil to be easily removed from the poly-based film and the adhesive.

11. The method of claim 10, wherein the adhesive is uniform across a surface of the poly-based film and uniform across the surface of the thin copper foil.

12. The method of claim 11, wherein the adhesive is permanently applied to the poly-based film.

13. The method of claim 1, wherein the adhesive is non-silicone based.

14. The method of claim 1, wherein the adhesive is an acrylic adhesive.

15. The method of claim 1, wherein the poly-based film is one that does not deteriorate under heating at temperatures of one hundred and eighty degrees Celsius.

16. The method of claim 1, wherein the adhesive is applied uniformly across a surface of the poly-based film and uniformly across the surface of the thin copper foil.

17. The method of claim 1, wherein the poly-based film has a thickness of 45 microns or greater.

18. The method of claim 1, wherein the poly-based film has a thickness of between 45 and 100 microns.
